(19) United States
(12) Patent Application Publication
(10) Pub. No.: US 2010/0076133 A1
(43) Pub. Date: Mar. 25, 2010

(54) POLYESTER RESIN COMPOSITION AND MOLDED PRODUCT

(75) Inventor: Yu Yamaguchi, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/524,659

(22) PCT Filed: Apr. 23, 2009
(86) PCT No.: PCT/JP2009/058541

§ 371 Date: Jul. 27, 2009

(30) Foreign Application Priority Data
Apr. 25, 2008 (JP) 2008-116131

(51) Int. Cl. C08K 5/54

(52) U.S. Cl. 524/188

(57) ABSTRACT

A polyester resin composition containing a phyllosilicate and a polyester, the phyllosilicate being subjected to an ion exchange with a quaternary onium cation having at one end of the molecule a structure that affords a silanol group (Si—OH) by hydrolysis.

### TECHNICAL FIELD

The present invention relates to a polyester resin composition containing a polyester and a phyllosilicate, which has been treated by a specific ion exchange, and to a molded or extruded product.

### BACKGROUND ART

Polyesters are widely used in films, molding materials and so forth, utilizing their excellent mechanical strength, heat resistance, weatherability, chemical resistance, and the like properties. Further, mixing of such a polyester with a reinforcing filler improves the strength and heat resistance of the resin. The resulting reinforced compositions are favorable as materials for mechanical component parts. Examples of a reinforcing filler that can be used include inorganic powders, such as talc, glass fiber, phyllosilicate, and so forth. Where such powdery fillers are used, they must be added at a high mixing ratio in order to obtain resin compositions by melt kneading or the like. Also, there have been problems with workability and dispersibility.

Accordingly, it is believed that exchangeable cations present between layers of a phyllosilicate are exchanged with organic onium ions so as to make the phyllosilicate delaminate with ease and also to improve its affinity for a resin. In Japanese Patent Laid-open Application No. 2003-073538, a technique is disclosed by which a resin composition is obtained containing a layered clay mineral, which has been organized with polylactic acid and an organic onium salt having a hydroxyl group and has combined with polylactic acid through the hydroxyl group of the organic onium salt. According to this technique, a resin composition that has good rigidity and a sufficiently high crystallization speed can be obtained by uniformly dispersing the layered clay mineral in a polylactic acid resin.

Also, Japanese Patent No. 3767965 discloses a technique by which a biodegradable resin composition is obtained, characterized in that it comprises i) a biodegradable resin containing 50 parts by weight or more of polylactic acid and ii) a phyllosilicate having between layers thereof a primary to tertiary amine salt, a quaternary ammonium salt, or a phosphonium salt, and contains a reactive compound containing at least one unit of a functional group selected from an epoxy, an isocyanate, an acid anhydride, and an alkoxysilane. According to this technique, a biodegradable resin composition can be obtained, which has improved interfacial strength between the resin and the phyllosilicate and has superior heat resistance and mechanical properties. Here, shown as a method by which the reactive compound is added, is a method in which the reactive compound is previously mixed with the resin and reacted with the latter, a method in which the reactive compound is previously mixed with a phyllosilicate having been treated with an organic cation and reacted with the latter, or a method in which a phyllosilicate having been treated with the resin and an organic cation and the reactive compound are simultaneously added at the time of melt-kneading and reacted with each other.

However, in the method in which a phyllosilicate treated with the resin and an organic cation and the reactive compound are simultaneously added at the time of melt-kneading and reacted with each other, the reactive compound is insufficient for the reinforcement of the mutual action between the resin and the phyllosilicate. Also, it is necessary to remove an alcohol produced as a result of the reaction.

Meanwhile, in the method in which the reactive compound is previously reacted with the resin or the phyllosilicate, the step of reacting these compounds inevitably makes the operation complicated. In addition, an affinity of the organic cation for the reactive compound is an important factor in changing the physical properties of the resin composition. Hence, its selectivity is so complicated that full studies have had to be made. Moreover, even if the heat resistance and rigidity of the resin composition can be improved, there is a problem in that its impact resistance cannot be controlled. The above Japanese Patent Laid-open Application No. 2003-073538 and Japanese Patent No. 3767965 do not refer to the impact resistance.

### DISCLOSURE OF THE INVENTION

The present invention has been made taking into account such background art, and is to provide a polyester resin composition having superior heat resistance, rigidity, and impact resistance and a molded or extruded product making use of the same.

The present inventor has repeated extensive studies in order to resolve the above problems. As a result, it has been discovered that a resin composition containing a phyllosilicate, which has been subjected to an ion exchange with a quaternary onium cation having at one end of the molecule a structure that affords a silanol group (Si—OH) by hydrolysis, can have superior heat resistance, rigidity, and impact resistance. Here, in the step of treating the phyllosilicate with the quaternary onium cation, there is no addition in the number of production steps necessary for the reaction with any reactive compound that may take place as in the background art. Also, the phyllosilicate is uniformly dispersed in the resin in the state where the former has an extended interlayer spacing. Also, the resin and the phyllosilicate, having been subjected to ion exchange, have a high interfacial strength between them. Hence, the resin composition can simultaneously improve heat resistance, rigidity, and impact resistance.

That is, the polyester resin composition that can resolve the above problems is characterized by containing a phyllosilicate and a polyester, the phyllosilicate being subjected to an ion exchange with a quaternary onium cation having at one end of the molecule a structure that affords a silanol group (Si—OH) by hydrolysis.

The present invention is also related to a molded or extruded product formed from the above resin composition.

According to the present invention, there can be provided a polyester resin composition having superior heat resistance, rigidity, and impact resistance, and a molded or extruded product making use of the same.

Further features of the present invention will become apparent from the following description of exemplary embodiments with reference to the attached drawing.

### BRIEF DESCRIPTION OF THE DRAWING

FIG. 1 is a diagrammatic view of the results of the observation via a transmission electron microscope, showing how the phyllosilicate in the resin composition is present as a structure formed from a single layer to a plurality of layers.

### BEST MODE FOR CARRYING OUT THE INVENTION

Embodiments of the present invention are described below.

The polyester resin composition according to the present invention is a resin composition characterized by containing a phyllosilicate and a polyester, with the phyllosilicate having been subjected to an ion exchange with a quaternary onium cation having at one end of the molecule a structure that affords a silanol group (Si—OH) by hydrolysis. It has superior heat resistance, rigidity, and impact resistance.

The polyester resin constituting the polyester resin composition according to the present invention refers to a resin composed of at least one selected from polybasic carboxylic acids including a dicarboxylic acid, and ester-forming derivatives thereof, and at least one selected from polyhydric alcohols including a glycol; or a resin composed of a hydroxycarboxylic acid and an ester-forming derivative thereof; or a resin composed of a cyclic ester.

The dicarboxylic acid may include saturated aliphatic dicarboxylic acids, such as oxalic acid, malonic acid, succinic acid, glutaric acid, adipic acid, pimelic acid, suberic acid, azelaic acid, sebacic acid, decane dicarboxylic acid, dodecane dicarboxylic acid, tetradecane dicarboxylic acid, hexadecane dicarboxylic acid, 3-cyclobuane dicarboxylic acid, 1,3-cyclopentane dicarboxylic acid, 1,2-cyclohexane dicarboxylic acid, 1,3-cyclohexane dicarboxylic acid, 1,4-cyclohexane dicarboxylic acid, 2,5-norbornane dicarboxylic acid and dimeric acid, or ester-forming derivatives of these; unsaturated aliphatic dicarboxylic acids, such as fumaric acid, maleic acid and itaconic acid, or ester-forming derivatives of these; aromatic dicarboxylic acids, such as orthophthalic acid, isophthalic acid, terephthalic acid, furan dicarboxylic acid, diphenic acid, 1,3-naphthalene dicarboxylic acid, 1,4-naphthalene dicarboxylic acid, 1,5-naphthalene dicarboxylic acid, 2,6-naphthalene dicarboxylic acid, 2,7-naphthalene dicarboxylic acid, 4,4′-biphenyl dicarboxylic acid, 4,4′-biphenyl sulfone dicarboxylic acid, 4,4′-biphenyl ether dicarboxylic acid, 1,2-bis(phenoxy)ethane-p,p′-dicarboxylic acid, pamoic, and anthracene dicarboxylic acid, or ester-forming derivatives of these; and metal sulfonate group-containing aromatic dicarboxylic acids, such as 5-sodium sulfoisophthalic acid, 2-sodium sulfoterephthalic acid, 5-lithium sulfoisophthalic acid, 2-lithium sulfoterephthalic acid, 5-potassium sulfoisophthalic acid and 2-potassium sulfoterephthalic acid, or ester-forming derivatives of these.

The polybasic carboxylic acid, other than these dicarboxylic acids, may include ethane tricarboxylic acid, propane tricarboxylic acid, butane tetracarboxylic acid, pyromellitic acid, trimellitic acid, trimesic acid, 3,4,3′,4′-biphenyl tetracarboxylic acid, and ester-forming derivatives thereof.

The glycol may include aliphatic glycols, such as ethylene glycol, 1,2-propylene glycol, 1,3-propylene glycol, diethylene glycol, triethylene glycol, 1,2-butylene glycol, 1,3-butylene glycol, 2,3-butylene glycol, 1,4-butylene glycol, 1,5-pentanediol, neopentyl glycol, 1,6-hexanediol, 1,2-cyclohexanediol, 1,3-cyclohexanediol, 1,4-cyclohexanediol, 1,2-cyclohexane dimethanol, 1,3-cyclohexane dimethanol, 1,4-cyclohexane dimethanol, 1,4-cyclohexane diethanol, 1,10-decamethylene glycol, 1,12-dodecanediol, polyethylene glycol, polytrimethylene glycol and polytetramethylene glycol; and aromatic glycols, such as hydroquinone, 4,4-dihydroxybisphenol, 1,4-bis(β-hydroxyethoxy)benzene, 1,4-bis(β-hydroxyethoxyphenyl)sulfone, bis(p-hydroxyphenyl)ether, bis(p-hydroxyphenyl)sulfone, bis(p-hydroxyphenyl)-methane, 1,2-bis(p-hydroxyphenyl)-ethane, bisphenol A, bisphenol C, 2,5-naphthalenediol, and glycols formed by adding ethylene oxide to any of these glycols.

The polyhydric alcohol, other than these glycols, may include trimethylol methane, trimethylol ethane, trimethylol propane, pentaerythritol, glycerol, and hexanetriol.

The hydroxycarboxylic acid may include lactic acid, citric acid, malic acid, tartaric acid, hydroxyacetic acid, 3-hydroxybutyric acid, p-hydroxybenzoic acid, p-(2-hydroxyethoxy)benzoic acid and 4-hydroxycyclohexane carboxylic acid, or ester-forming derivatives thereof.

The cyclic ester may include an c-caprolactone, a β-propiolactone, a β-methyl-β-propiolactone, a δ-valerolactone, a glycolide, and a lactide.

The ester-forming derivatives of polybasic carboxylic acids or hydroxycarboxylic acids may include alkyl esters, acid chlorides, or acid anhydrides thereof.

Examples of the polyester resin include poly(α-hydroxy acids), such as polyethylene terephthalate, polypropylene terephthalate, polybutylene terephthalate, polyhexamethylene terephthalate, polycyclohexane-1,4-dimethyl terephthalate, neopentyl terephthalate, polyethylene furan dicarboxylate, polypropylene furan dicarboxylate, polybutylene furan dicarboxylate, polyethylene isophthalate, polyethylene naphthalate, polybutylene naphthalate, polyhexamethylene naphthalate, polylactic acid, polyhydroxyl butyrate, polybutylene succinate, polyglycolic acid, polycaprolactone, polybutylene terephthalate, polyethylene-2,6-naphthalate, polyethylene-α,β-bis(2-chlorophenoxy)ethane-4,4′-dicarboxylate, polyethylene succinate, polybutylene succinate, polybutylene succinate adipate, polyhexamethylene succinate, polyethylene adipate, polyhexamethylene adipate, polybutylene adipate, polyethylene oxalate, polybutylene oxalate, polyneopentyl oxalate, polyethylene sebacate, polybutylene sebacate, polyhexamethylene sebacate, polyglycolic acid and polylactic acid, or copolymers of these; poly(ω-hydroxyalkanoates) such as poly(ε-caprolactone) and poly(β-propiolactone); poly(β-hydroxyalkanoates) such as poly(3-hydroxybutyrate), poly(4-hydroxybutyrate), poly(3-hydroxyvalerate), poly(3-hydroxycaprate), poly(3-hydroxyheptanoate), and poly(3-hydroxyoctanoate); and copolymer polyesters of any of these. Any of these polyester resins may be used alone or may be used in combination of two or more types thereof.

Of the above polyester resins, polylactic acid is preferred.

The polylactic acid refers to one obtained by polymerizing lactic acid, which draws attention from the viewpoint of biomass utilization and biodegradability. The L-form or D-form of the lactic acid may preferably have an optical purity of 90% or more as having a high melting point. As long as the properties of the polylactic acid are not damaged, it may be copolymerized with any component other than lactic acid, or may contain any polymer other than polylactic acid, or additive(s), such as particles, a flame retardant, an antistatic agent, a crystal nucleating agent, and/or a hydrolysis preventive. However, from the viewpoint of biomass utilization and biodegradability, the content of the lactic acid monomer may preferably be at least 50% by weight. The polylactic acid polymer may preferably have, as the weight average molecular weight, a molecular weight of 50,000 to 500,000, which should provide a good balance between mechanical properties and moldability.

The phyllosilicate used in the present invention means a swelling phyllosilicate, and any commonly available nano-composite materials may be used, as exemplified by a smectite, such as montmorillonite or saponite, swelling mica, graphite, and imogolite. In particular, montmorillonite and swelling mica may preferably be used, and swelling mica may particularly preferably be used.

As the quaternary onium cation having at one end of the molecule a structure that affords a silanol group (Si—OH) by hydrolysis, with which cation any of these phyllosilicates are to be treated by the ion exchange, usable are a quaternary ammonium ion having a methoxy group, a quaternary ammonium ion having an ethoxy group, a quaternary ammonium ion having an acetoxy group, a phosphonium ion having a methoxy group, a phosphonium ion having an ethoxy group, and a phosphonium ion having an acetoxy group. Further, a cation that has a long-chain alkyl group in the molecule is preferable, because it is effective in extending the interlayer spacing of the phyllosilicate so as to be uniformly dispersed in the resin with ease.

The quaternary onium cation having at one end of the molecule a structure that affords a silanol group (Si—OH) by hydrolysis that may satisfy such features has an appropriate molecular diameter and, at the same time, has a high affinity for the resin. Hence, such an organized phyllosilicate is uniformly dispersed in the resin in the where state the former has an extended interlayer spacing and also can enjoy a high interfacial strength between the resin and the organized phyllosilicate.

Examples of the quaternary onium cation having at one end of the molecule a structure that affords a silanol group (Si—OH) by hydrolysis may include an octadecyldimethyl[3-(trimethoxysilyl)propyl]ammonium ion and a trimethyl[3-(triethoxysilyl)propyl]ammonium ion. Any of these cations may be used alone or may be used in combination of two or more types.

Of these, the octadecyldimethyl[3-(trimethoxysilyl)propyl]ammonium ion is known to have antimicrobial properties, and is used as an antimicrobial agent in medical, dental, and industrial materials. Accordingly, an effect can be expected such that the resin composition is provided with antimicrobial properties by treating the phyllosilicate by ion exchange with the octadecyldimethyl[3-(trimethoxysilyl)propyl]ammonium ion and adding it to the polyester resin.

How to treat the phyllosilicate by ion exchange is described next. First, a smectite material of the phyllosilicate is dispersed in hot water of 60° C. to 90° C. while being swelled therein. The quaternary onium cation having at one end of the molecule a structure that affords a silanol group (Si—OH) by hydrolysis is slowly added to the obtained dispersion, and the mixture is stirred in the hot water for about 20 hours to about 30 hours to effect the ion exchange for exchangeable ions present between layers of the phyllosilicate. The suspension obtained is filtered, and the solid obtained is repeatedly washed with hot water to remove residual sodium ions and excess onium cations. Finally, this solid is dried in an oven, followed by pulverization by means of a grinding mill to obtain a powdery treated phyllosilicate.

Here, the quaternary onium cation having at one end of the molecule a structure that affords a silanol group (Si—OH) by hydrolysis may be added in an amount of from 0.7 in equivalent weight to 1.2 in equivalent weight, and preferably from 0.8 in equivalent weight to 1.0 in equivalent weight, based on 1 equivalent weight of the ion exchange capacity of the phyllosilicate. If it is in an amount smaller than 0.7 in equivalent weight, the ion exchange between sodium ions of the phyllosilicate and ammonium ions may be insufficient to make the phyllosilicate not sufficiently dispersed. If, however, it is present in an amount larger than 1.2 in equivalent weight, the polyester resin composition may have low impact resistance, which would prevent the product from achieving both heat and impact resistance.

Next, the above-treated phyllosilicate (organized phyllosilicate) is dispersed in the resin by means of a high-dispersion mixer. First, the resin is put into a high-dispersion mixer controlled to a temperature not lower than the melting point of the resin. Thereafter, the resin is kneaded with the addition of the treated phyllosilicate. The shear force produced by blades of the mixer causes the treated phyllosilicate to delaminate gradually, so that the phyllosilicate becomes dispersed as a structure formed from a single layer to a plurality of layers.

The phyllosilicate may be added in an amount of from 0.1 part by mass or more to 30 parts by mass or less, preferably from 1 part by mass or more to 10 parts by mass or less, and more preferably from 1 part by mass or more to 5 parts by mass or less, based on 100 parts by mass of the polyester and the phyllosilicate in total. If the phyllosilicate is added in an amount of less than 0.1 part by mass, the resin composition may not have markedly improved heat and impact resistance. However, the amount of the phyllosilicate is more than 30 parts by mass is not preferable, because of a disadvantage such as, for example, that any deterioration of the matrix resin may be accelerated under the influence of the onium ion component present in the resultant intercalation compound to make molding or extrusion difficult. The phyllosilicate may be used alone or may be used in combination of two or more types thereof.

The resin composition thus produced may be pelletized by means of a pelletizer. A molded or extruded product may also be obtained by using the above resin composition, and may be obtained by a process, which may include injection molding, extrusion, hollow casting, compression molding, thermoforming, laminate molding, and rotational molding.

### Examples

The present invention is described below in greater detail by giving Examples. Note that, needless to say, the present invention is by no means limited by the following Examples, and may variously be modified unless it is beyond its gist.

On the following items, a measurement was made in the following way.

(1) Ion Exchange Level:

Determined from ignition loss (%) at 1,000° C. and molecular weight of intercalated cations of the organized phyllosilicate, and according to the following expression. Ion exchange level (mmol/100 g)=(ignition loss/cation molecular weight)×{100/(100−ignition loss)}×1,000.

(2) Ion Exchange Capacity:

Determined on the basis of a method for measuring the cation exchange capacity of bentonite (powdery one) (JBAS-106-77) according to Japan Bentonite Manufacturers Association Standard Test Method. More specifically, using an apparatus in which decoction containers are connected in its longitudinal direction, all ion-exchangeable cations present between layers of the phyllosilicate were exchanged into NH₄⁺ ions, using an aqueous 1N ammonium acetate solution pH-adjusted to 7. Thereafter, after thorough washing with water and ethyl alcohol, the NH₄⁺-type phyllosilicate was immersed in an aqueous 10% by mass potassium chloride solution, where NH₄⁺ ions in the sample were exchanged into K⁺ ions. Subsequently, the NH₄⁺ ions, having leached with the above ion exchange reaction, were subjected to neutralization titration by using an aqueous 0.1N sodium hydroxide solution to determine the cation exchange capacity (milli-equivalent weight/100 g) of the raw-material swelling phyllosilicate.

### Example 1

To 100 g of a phyllosilicate, swelling fluorine mica (a sodium type) SOMASIF ME-100 (trade name; ion exchange capacity: 120 meq/100 g; available from CO-OP Chemical Co., Ltd.), 0.99 liter of 60° C. hot water was added with stirring to disperse the former while swelling it. Thereafter, to the dispersion obtained, 0.99 liter of an aqueous solution containing 5 parts by mass of octadecyldimethyl[3-(trimethoxysilyl)propyl]ammonium chloride was slowly added, and the mixture obtained was kept at 60° C. and stirred for 24 hours to effect the ion exchange reaction to exchange sodium ions of the former into the ions of the latter. The precipitate formed was separated by filtration and then repeatedly washed with ultra-pure water to remove residual sodium ions, followed by drying, and then pulverization by means of a grinding mill was performed to obtain a powdery treated phyllosilicate.

Using a mixer LABO PRASTOMILL (trade name; blades: roller type; manufactured by Toyo Seiki Seisakusho, Ltd.), 5 parts by mass of the treated (organized) phyllosilicate obtained as above was added to 95 parts by mass of a resin composed of polylactic acid (trade name: LACEA H100J, available from Mitsui Chemicals, Inc.), which were melt-kneaded while the former was added to the latter, under conditions of a temperature of 180° C., twin-screw reverse rotation, and a number of revolutions of 50 rpm to prepare a resin composition.

The resin composition obtained was pelletized and, using the pellets obtained, a noncrystalline strip-type specimen (80 mm×10 mm×4.0 mm thick) was produced by using an injection molding machine (trade name: SE18DU; manufactured by Sumitomo Heavy Industries, Ltd.) and at a mold temperature of 25° C. Thereafter, the strip-type specimen obtained was kept in a 110° C. oven for 30 minutes to obtain a crystal-state strip-type specimen.

### Example 2

A crystal-state strip-type specimen was produced in the same way as in Example 1, except that the noncrystalline strip-type specimen was kept at a mold temperature of 110° C. for 5 minutes and the heating in the oven was not conducted.

### Example 3

A crystal-state strip-type specimen was produced in the same way as in Example 1, except that pellets of a resin composition were used. It was obtained by adding the organized phyllosilicate obtained in Example 1, in an amount of 1 part by mass, to 99 parts by mass of the resin.

### Example 4

A crystal-state strip-type specimen was produced in the same way as in Example 1, except that pellets of a resin composition were used. It was obtained by adding the organized phyllosilicate obtained in Example 1, in an amount of 10 parts by mass, to 90 parts by mass of the resin.

### Comparative Example 1

A crystal-state strip-type specimen was produced in the same way as in Example 1, except that pellets of a resin composition were used. It was obtained by using, in place of the organized phyllosilicate obtained in Example 1, a commercially available organized phyllosilicate (trade name: SOMASIF MEE; available from CO-OP Chemical Co., Ltd.), having been subjected to an ion exchange with a dodecylbis[(hydroxyethyl)methyl]ammonium ion.

### Comparative Example 2

A crystal-state strip-type specimen was produced in the same way as in Example 1, except that pellets of a resin composition were used. It was obtained by using, in place of the organized phyllosilicate obtained in Example 1, a phyllosilicate obtained by treating SOMASIF MEE with 3-grycidyl oxypropyl(dimethoxy)methylsilane.

### Comparative Example 3

A crystal-state strip-type specimen was produced in the same way as in Example 1, except that pellets of a resin composition were used. It was obtained by using SOMASIF MEE in place of the organized phyllosilicate obtained in Example 1, and melt-kneading the materials while simultaneously dropwise adding 3-grycidyl oxypropyl(dimethoxy)methylsilane.

### Comparative Example 4

A crystal-state strip-type specimen was produced in the same way as in Example 1, except that pellets of a resin composition were used. It was obtained by using, in place of the organized phyllosilicate obtained in Example 1, a commercially available unorganized phyllosilicate (trade name: SOMASIF ME-100; available from CO-OP Chemical Co., Ltd.).

### Comparative Example 5

A crystal-state strip-type specimen was produced in the same way as in Example 1, except that pellets of a resin composition were used. It was obtained without adding any organized phyllosilicate.

Comparison Test 1

With respect to the crystal-state strip-type specimens obtained in Examples 1 to 4 and Comparative Examples 1 to 4, the interlayer spacing of each organized phyllosilicate was measured once in each case with an X-ray diffraction analyzer (XRD) X'Pert Pro (trade name; manufactured by Philips Electronics N.V.). Where the resin is intercalated between layers of the phyllosilicate and the interlayer spacing of the phyllosilicate is extended, the diffraction peak shifts on the low-angle side and the peak diminishes.

Comparison Test 2

The crystal-state strip-type specimens obtained in Examples 1 to 4 and Comparative Examples 1 to 4 were each sliced in thin pieces by using Ultramicrotome EM UC6 (trade name; manufactured by Ernst Leitz Optische Werke Ag.), and the state of dispersion of the phyllosilicate was ascertained on a transmission electron microscope H800 (trade name; manufactured by Hitachi Ltd.).

Comparison Test 3

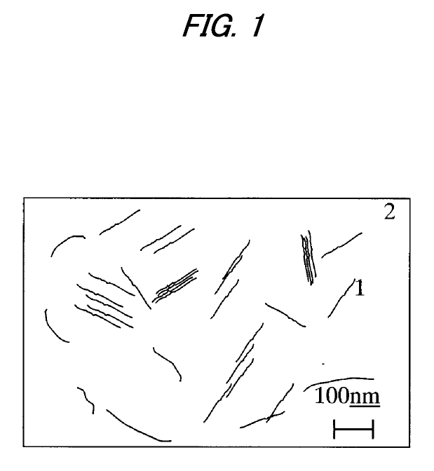

The dispersibility of phyllosilicate in the crystal-state resin composition obtained in Examples 1 to 4 and Comparative Examples 1 to 4 each was evaluated by the methods in Comparison Tests 1 and 2 to obtain results shown in Table 1. In Table 1, letter symbol A indicates that the transmission electron microscope observation has ascertained a state in which the layered structure of the phyllosilicate has collapsed and, as shown in FIG. 1, layers of about 1 nanometer in thickness, which form the phyllosilicate, are present as a structure formed from a single layer to a plurality of layers, and also that the measurement with the XRD has ascertained the extended interlayer spacing of the phyllosilicate and the peak as having diminished. Letter symbol C indicates that the layered structure has been ascertained as having 10 or more layers or the phyllosilicate stands agglomerate.

TABLE 1

| | Resin composition | Dispersibility |
|---|---|---|
| Example: | | |
| 1 | Crystal-state polyester resin composition | A |
| 2 | Crystal-state polyester resin composition | A |
| 3 | Crystal-state polyester resin composition | A |
| 4 | Crystal-state polyester resin composition | A |
| Comparative | | |
| Example: | | |
| 1 | Crystal-state polyester resin composition | A |
| 2 | Crystal-state polyester resin composition | A |
| 3 | Crystal-state polyester resin composition | A |
| 4 | Crystal-state polyester resin composition | C |

As shown in Table 1, the treated (organized) phyllosilicates (Examples 1 to 4 and Comparative Examples 1 to 3) stood so dispersed that, in the polyester resin, the layers of about 1 nanometer in thickness, which formed the phyllosilicate, were present as a structure formed from a single layer to several layers.

Comparison Test 4

Heat resistance, rigidity (flexural modulus) and impact resistance of the crystal-state strip-type specimens obtained in Examples 1 to 4 and Comparative Examples 1 to 5 were evaluated by the following physical-property tests.

(1) Evaluation of Heat Resistance:

Using the strip-type specimens produced, the heat resistance of each resin composition of the above Examples and Comparative Examples was evaluated by load-deflection temperature. The measurement was conducted according to ISO 75 under flat-wise positioning at a stress of 0.45 MPa and at a heating rate of 2° C./min., and using a measuring instrument HDT/VSPT Tester TM-4126 (trade name; manufactured by Ueshima Seisakusho Co., Ltd.), on two specimens (number n=2) for each Example.

(2) Evaluation of Rigidity:

Using the strip-type specimens produced, the flexural modulus of each resin composition of the above Examples and Comparative Examples was evaluated by the three-point bending test. The measurement was conducted according to ISO 178 using a measuring instrument, a precision universal tester AUTOGRAPH AG-IS (trade name; manufactured by Shimadzu Corporation), on four specimens (number n=4) for each Example.

(3) Evaluation of Impact Resistance:

Using strip-type specimens produced, the impact resistance of each resin composition of the above Examples and Comparative Examples was evaluated by the Charpy impact value. The measurement was conducted according to ISO 179 under Type-A notches made by notching with Notching Tool A-3 (trade name; manufactured by Toyo Seiki Seisakusho, Ltd.), and using a measuring instrument Digital Impact Tester DG-UB (trade name; manufactured by Toyo Seiki Seisakusho, Ltd.), on four specimens (number n=4) for each Example.

The results of the physical property tests are shown in Table 2.

TABLE 2

| | | Heat | Flexural | Impact |
|---|---|---|---|---|
| | | resistance | modulus | resistance |
| | Resin composition | (° C.) | (MPa) | (kJ/m²) |
| Example: | | | | |
| 1 | Crystal-state polyester | 122 | 4,900 | 3.5 |
| | resin composition | | | |
| 2 | Crystal-state polyester | 124 | 4,900 | 3.5 |
| | resin composition | | | |
| 3 | Crystal-state polyester | 119 | 4,200 | 3.3 |
| | resin composition | | | |
| 4 | Crystal-state polyester | 127 | 5,300 | 3.1 |
| | resin composition | | | |
| Comparative | | | | |
| Example: | | | | |
| 1 | Crystal-state polyester | 117 | 5,200 | 1.1 |
| | resin composition | | | |
| 2 | Crystal-state polyester | 115 | 5,000 | 1.3 |
| | resin composition | | | |
| 3 | Crystal-state polyester | 108 | 4,900 | 1.7 |
| | resin composition | | | |
| 4 | Crystal-state polyester | 110 | 4,600 | 2.8 |
| | resin composition | | | |
| 5 | Crystal-state polyester | 97 | 3,900 | 3.0 |
| | resin composition | | | |

As shown in Table 2, Examples 1 to 4 composed according to the present invention were compared with the polylactic acid composition shown in Comparative Example 5 as a control and were found to have greatly been improved in heat resistance. It was also found that the rigidity has remained substantially the same or impact resistance has somewhat been improved. That is, typically, the addition of any phyllosilicate decreases impact resistance of resin compositions, whereas in accordance with the present invention, the problems of heat resistance, rigidity, and impact resistance have been resolved through the same number of steps as that in producing compositions to which any conventional organized phyllosilicate has been added.

In Comparative Example 2, in which the alkoxysilane is reacted with the organized phyllosilicate, in Comparative Example 3, in which the alkoxysilane is added at the time of kneading, and in Comparative Example 4, in which the phyllosilicate that is not organized is added, heat resistance, rigidity, and impact resistance were not simultaneously improved.

### POSSIBILITY OF INDUSTRIAL APPLICATION

The present invention is concerned with dispersion of a reinforcing additive material to improve the physical properties of polyesters, and can be widely utilized in industrial fields that employ polyester resins, which are required to have heat resistance, rigidity, and impact resistance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-116131, filed Apr. 25, 2008, which is hereby incorporated by reference herein in its entirety.

1. A polyester resin composition comprising a phyllosilicate and a polyester; the phyllosilicate being subjected to ion exchange with a quaternary onium cation having at one end of the molecule a structure that affords a silanol group (Si—OH) by hydrolysis.

2. The polyester resin composition according to claim 1, wherein the quaternary onium cation is octadecyldimethyl[3-(trimethoxysilyl)propyl]ammonium ion.

3. The polyester resin composition according to claim 1, wherein the phyllosilicate is swelling mica.

4. The polyester resin composition according to claim 1, wherein the polyester is polylactic acid.

5. The polyester resin composition according to claim 1, wherein the phyllosilicate is contained in an amount of from 0.1 part by mass or more to 30 parts by mass or less based on 100 parts by mass of the polyester and the phyllosilicate in total.

6. The polyester resin composition according to claim 1, wherein the phyllosilicate is dispersed as a structure formed of from a single layer to a plurality of layers.

7. A molded or extruded product formed by using the resin composition according to claim 1.
